(19) United States
(12) Patent Application Publication
(10) Pub. No.: US 2004/0107177 A1
(43) Pub. Date: Jun. 3, 2004

(54) Automated content filter and URL translation for dynamically generated web documents

(76) Inventors: Bruce Elliott Covill, Phoenix, AZ (US); Scott Clifford Moore, Mesa, AZ (US)

Correspondence Address: LinkDriver.Com LLC, Suite 210, 2211 East Highland Ave., Phoenix, AZ, 85016, US

(21) Appl. No.: 10/459,890

(22) Filed: Jun. 12, 2003

Related U.S. Application Data
(60) Provisional application No. 60/389,371, filed on Jun. 17, 2002.

(51) Int. Cl. G06F 7/00

(52) U.S. Cl. 707/1

(57) ABSTRACT

Embodiments provide a method, process and apparatus for filtering a request from a client and building the response to that request using mapping tables. These mapping tables are utilized to present content-related information about hypertext documents that can be dynamically generated from a database, on one or more servers. The dynamically generated hypertext documents may be web pages for the World Wide Web portion of the Internet. The mapping table is used to automatically generate a mapping page to best match its intended viewer's request. A mapping page designed to be viewed by a computer system will be presented in a format optimized for use by a web crawler program to build an index of web pages that may be generated at the server site. A mapping page designed to be viewed by a person will be presented in a human readable format, with optimizations made based on how that user arrived at the page. A site operator will enter the basic information required to generate the first mapping table entries, including information required to build a data access algorithm. Data used in these mapping tables, including the URL (uniform resource locator), keyword data and content, is fetched by an automated web browser (spider) through the HTTP (hyper text transport protocol) transport using the data access algorithm generated. Site operators may specify initial logical data groupings. Mapping table entries may be continuously updated, and subsequent entries may be automatically generated based on the criteria that was used in the requesting query. Individual table entries may be influenced by a predetermined algorithm as designated by the industry that the site operator has selected.

An additional embodiment provides a method, process and apparatus allowing a human to train a program that creates the mapping table, showing the apparatus various methods for finding dynamically generated data by example. The apparatus then uses the examples to generate the mapping table and the resulting mapping algorithms.

Applicant claims priority of provisional application Serial No. 60/389,371 filed Jun. 7, 2002.

### BACKGROUND OF THE INVENTION

1. Field of the Invention

Embodiments of the invention generally relate to data-processing. More particularly, the invention relates to the use of HTTP requests and responses within a computer network or over the World Wide Web, where the request and response are processed within a web server.

2. Background of the Related Art

In prior art, it has been well known that computer systems can be used to parse, index, and search World Wide Web pages. It has also been shown in prior art that computer systems can be used to manage indices to records in databases. However, automatically indexing records in a database used to generate dynamic web pages in plurality presents a different problem.

Recently, the Internet computer network has grown to have hundreds of millions of World Wide Web pages accessible to anyone with a communications link to the Internet. These pages are dispersed over millions of servers across the world. Internet search engines serve as a global repository of the locations and content of many of these pages. However, many sites do not actually have any pages capable of being indexed by most current web search engines using traditional means, because their pages are dynamically generated on the fly based on user input. These pages may be built differently for every user that comes to the page.

In prior art, attempts have been made to create intermediary static HTML pages that represent the anticipated result of a dynamic response to a specific request. Where these pages are human readable, they are referred to as doorway pages. Where the pages are designed only as a redirection mechanism, they are referred to as gateway pages. These pages may create the desired result in allowing the indexing mechanisms of search engines to find what otherwise would not be represented, however, the maintenance of these alternative pages becomes a constant task. Whenever a new product or potential search result is added to the database, the doorway or gateway page must be modified.

On the Internet, a select number of search engines direct a majority of user traffic. These prior-art search engines are not industry specific, and thus cannot build indices that are meaningful in all industries they serve. It is also a problem to minimize the locations in which data must be modified. As one possible solution to this problem, some prior-art embodiments have built static hypertext documents, targeted at specific industries. These static pages have a high latency to update, large space requirements, and cannot handle exceptions at the time they are requested. Where more than one targeted industry exists, the maintenance requirement expands geometrically.

With dynamically generated hypertext pages, the requesting user's form parameters are passed to the page as specified in prior-art. However, these parameters use non-industry standard characters, which have proven to be difficult for people to verbally exchange, or use in marketing.

Dynamically generated pages do not have the same characteristics as static HTML pages. The primary difference is that a static page has a known length or size, where a dynamically generated page will vary in size depending on the result of the request. Since it is generated upon request, the page that is returned is not completed until after the initial response has begun. As a result, the dynamically generated page has no way of anticipating its length. This characteristic causes some current web browsers to fail, particularly those in use in Personal Digital Assistants and Cellular Devices.

### SUMMARY OF THE INVENTION

Embodiments include a method and apparatus for filtering, analyzing and building a response to a request as processed by a web server.

This may occur by using a mapping table that has been previously generated.

The result of the analysis may be used to modify the mapping table using the request and result as new data for future mappings.

Upon receipt of an HTTP request, the apparatus may cause a reconstruction of the URL and query string, by using the data previously generated in a mapping table, in order to produce a response.

The requested data and the resultant response become additional data for the mapping table.

Upon the generation of the dynamic HTML page, the apparatus then redirects the output to match the initial request, making the output appear to be a result from a static HTML page, including the appropriate length tags.

An additional embodiment permits the mapping table to be generated as the result of a training process wherein the apparatus is taught the method of generating mapping data as the result of following a human example. The various paths followed by the human trainer to retrieve dynamic data are used by the apparatus to find additional results, with this data being retained in the mapping table.

In either embodiment, the apparatus may additionally generate a virtual static HTML page representing the dynamic output from the data, allowing that data to be read by the indexing mechanisms of search engines or used to generate a site map.

### DESCRIPTION OF THE DRAWINGS

FIG. 1—Communication Diagram

FIG. 1 describes the network communication between the Client Browser (HTTP), the Search Engine Spider and the WWW Search Interface, and the Web Server. Also illustrated is the inter-process communication between the Web Server components and the Web Server Module (Inbound Filter, DGS Engine and Outbound Filter).

The DGS (Doorway, Gateway and Sitemap) Engine is the mechanism that is used to translate URL information as well as build additional mappings into the mapping table.

Network communications are represented by dashed lines, while inter-process communications are represented by solid lines.

FIGS. 2 (a, b, c)—Inbound Filter and DGS Engine Diagram

FIGS. 2 (a, b and c) is a flow chart showing the Web Module processing from the initial receipt of an HTTP request through completion of the Inbound Filter and DGS Engine processes.

FIG. 3—Outbound Filter Diagram

FIG. 3 is a flow chart showing the Web Module process for the final processing of an HTTP request through the Outbound Filter.

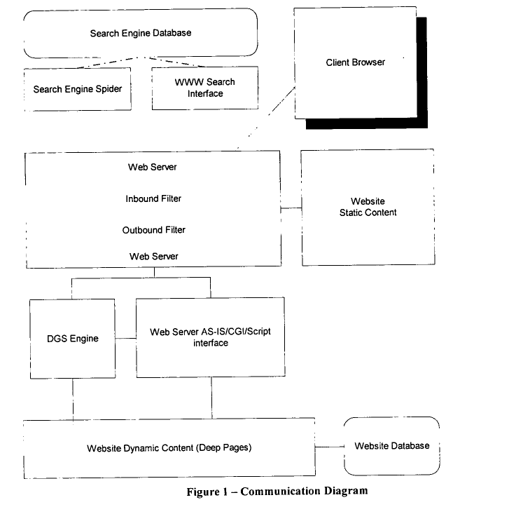

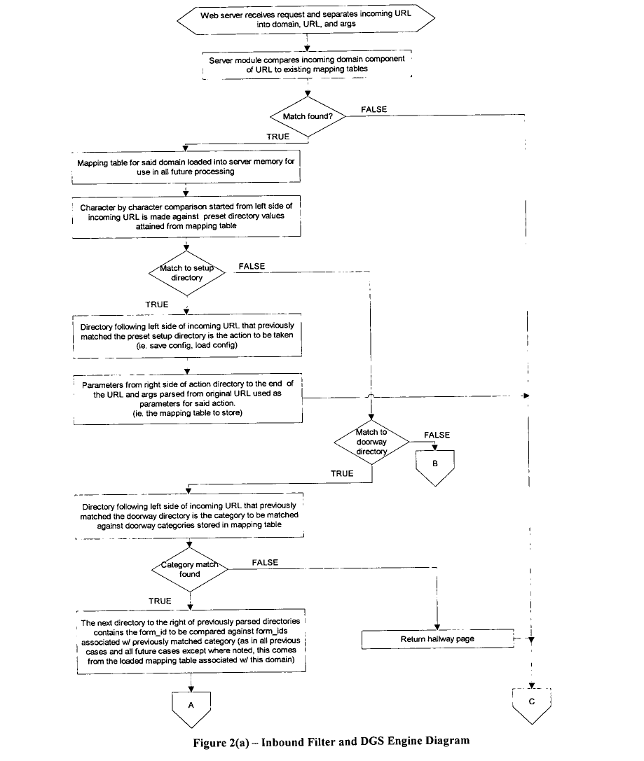

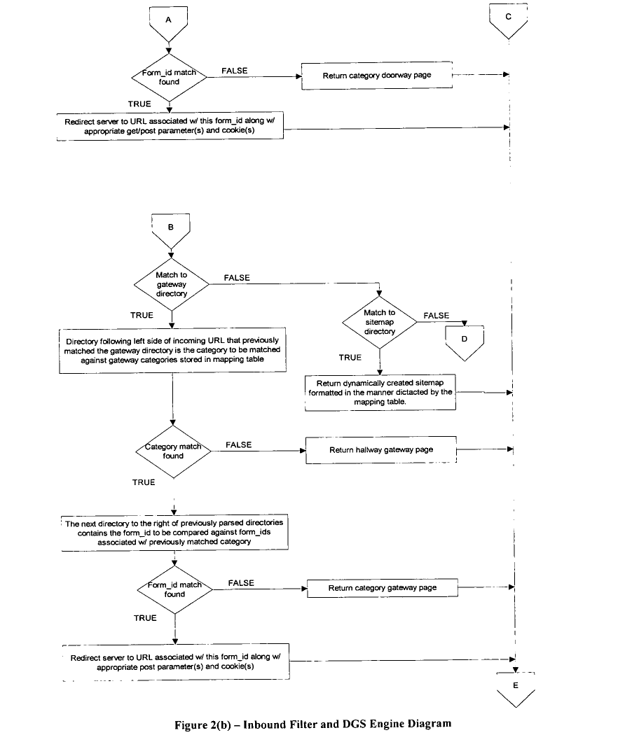

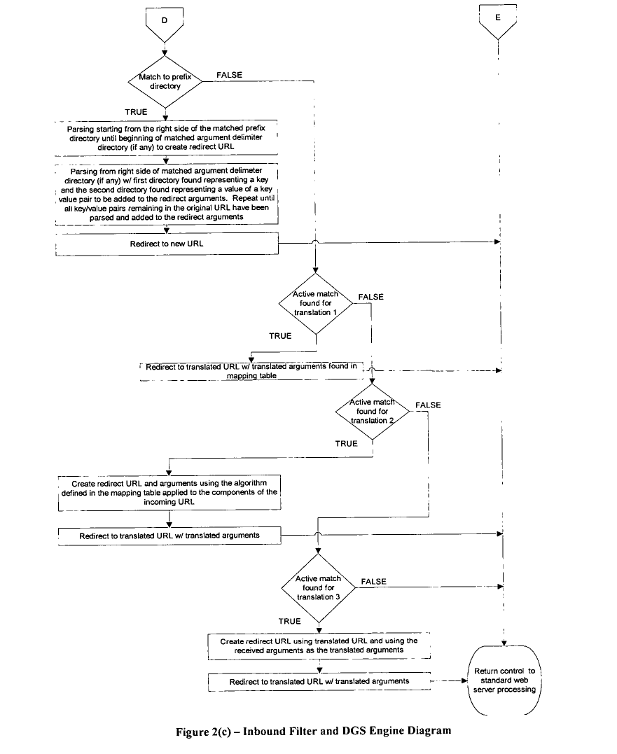

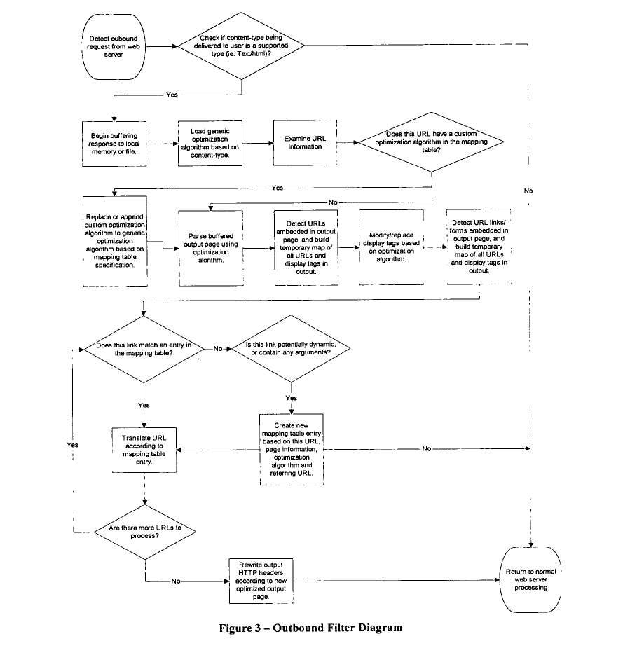

### DETAILED DESCRIPTION OF THE INVENTION

A description of the preferred embodiments of the invention follows. Various subsets of the above described environment exist in the prior art.

As used herein “query string” includes data appended to a URL within a request made by a client web browser to a web server. This data is appended in order to request a search of the underlying database in order to respond to the initiating request.

As used herein “mapping table” refers to an internal collection of data and stored algorithms stored accessible through multiple keys, grouped by domain, category, and URL information.

As used herein “mapping page” refers to a page of a type that provides access to one or more areas of a site's contents. Examples include doorway pages, hallway pages, gateway pages, and sitemap pages.

As used herein “doorway page” refers to a page for a particular subject item found on a site along with a list of hyperlinks to all locations on said site that this subject item can be found.

As used herein “hallway page” refers to a page of hyperlinks to doorway pages.

As used herein “gateway page” refers to doorway pages optimized for autonomous traversal by a computer.

As used herein “sitemap page” refers to a page containing the overview of a web site—a logical breakdown of the traversal area of a web site displayed in a human readable manner.

Upon receipt of a URL (which may include a query string), the standard web server begins processing the request. Immediately, the embodiment's logic interrupts the web server process, and begins to parse the request, initially determining whether the requested domain has been initialized within the mapping table. If it has not, the process is passed back to the web server, and no further function takes place within the embodiment.

Where the URL has been determined to be part of the mapped data, a determination is made whether the request matches the setup directory. If it does, the base URL determines the action to be taken, and the arguments from the original request are used as the parameters for that action. The process is passed back to the web server, and no further function takes place within the embodiment.

If the URL is not part of the mapped data, a determination is made as to whether the URL matches a doorway page as previously mapped. If not, successive determinations are made comparing the request to gateway and sitemap data in the mapping table. At each lever, where the requested URL does not result in a match, the URL is translated to the level above that request. In this way, requests for pages that do not or no longer exist result in a response showing alternate results.

The original URL request is held in memory. It and the resulting match are used by the outbound filter to update the data within the mapping table. In this way, the mapping table is heuristic.

Upon receiving a generated page from the web server in response to the original and/or reformatted request, an outbound filter reformats the response. The HTML as generated by the outbound filter appears to the initiating web client to have been a static HTML page, including the length tag (also known as an e-tag) that is not present in the dynamically generated page. In this way, normal HTML processing may be accomplished including translation and formatting by the web client.

An additional software component of the embodiment may be optionally used to anticipate incoming requests and their resultant translations. This administrative module allows a human user to follow the various paths normally used to gain access to deep level dynamically generated data in the web site. By supplying these examples, the administrative module is taught the path through the database that underlies the web site. It is then possible for that module to thoroughly examine the database and its linkage, creating additional entries in the mapping table as a result.

Where this optional module has been used to generate the mapping table, the heuristic mechanism included in the outbound filter continues to update the mapping table, but with more weight given to the data that was automatically generated by the administrative module.

What is claimed is:

1. In a distributed environment having a server computer holding a database and an algorithm for building an HTML page from that data, and a client computer that seeks access to at least one of the data records, a method comprising the steps of:
generating a mapping table at the server computer that holds information regarding contents of at least some of the database;
optimizing the mapping for the entity requesting it based on the user's request, past user requests, and industry standards;
examining the database through the HTTP for information changes to update the mapping generation engine;
providing the information in both machine, and human readable forms, including the URL;
creating virtual static HTML pages to aid in searches;
building new mappings based on past mapping use history; and
reformatting the dynamically generated HTML output to appear as a static page to the requesting web browser.

2. The method of claim 1 wherein the mapping table is used to generate a sitemap.

3. The method of claim 1 wherein a progressive mapping of a server determines indices that have changed, or are no longer available.

4. The method of claim 1 wherein users requesting indices no longer present are provided with alternate indices generated by a relevancy algorithm.

5. The method of claim 1 wherein the mapping table is generated on a different server from the database or web pages.

6. The method of claim 2 wherein the mapping table is generated on a different server from the database or web pages.

7. The method of claim 3 wherein the mapping table is generated on a different server from the database or web pages.

8. The method of claim 4 wherein the mapping table is generated on a different server from the database or web pages.

9. In a distributed environment having a server computer holding a database and an algorithm for building an HTML page from that data, and a client computer that seeks access to at least one of the data records, a method comprising the steps of:
generating a mapping table at the server computer that holds information regarding contents of at least some the database;
optimizing the mapping for the entity requesting it based on the user's request, past user requests, and industry standards;
examining the database through the HTTP for information changes to update the mapping generation engine;
providing the information in both machine, and human readable forms, including the URL;
creating virtual static HTML pages to aid in searches;
building new mappings based on the examples of searches accomplished by a human trainer; and
reformatting the dynamically generated HTML output to appear as a static page to the requesting web browser.

10. The method of claim 9 wherein the mapping table is used to build a sitemap.

11. The method of claim 9 wherein a progressive mapping of a server determines indices that have changed, or are no longer available.

12. The method of claim 9 wherein users requesting indices no longer present are provided with alternate indices generated by a site operator example.

13. The method of claim 9 wherein the mapping table is generated on a different server from the database or web pages.

14. The method of claim 10 wherein the mapping table is generated on a different server from the database or web pages.

15. The method of claim 11 wherein the mapping table is generated on a different server from the database or web pages.

16. The method of claim 12 wherein the mapping table is generated on a different server from the database or web pages.
